(19) United States
(12) Patent Application Publication
(10) Pub. No.: US 2024/0038255 A1
(43) Pub. Date: Feb. 1, 2024

(54) SPEAKER DIARIZATION METHOD, SPEAKER DIARIZATION DEVICE, AND SPEAKER DIARIZATION PROGRAM

(71) Applicant: NIPPON TELEGRAPH AND TELEPHONE CORPORATION, Tokyo (JP)

(72) Inventors: Atsushi ANDO, Tokyo (JP); Yumiko MURATA, Tokyo (JP); Takeshi MORI, Tokyo (JP)

(73) Assignee: NIPPON TELEGRAPH AND TELEPHONE CORPORATION, Tokyo (JP)

(21) Appl. No.: 18/266,166

(22) PCT Filed: Dec. 10, 2020
(86) PCT No.: PCT/JP2020/046117

§ 371 Date: Jun. 8, 2023

(51) Int. Cl. G10L 21/028; G10L 17/02; G10L 17/04

(52) U.S. Cl. CPC G10L 21/028; G10L 17/02; G10L 17/04

(57) ABSTRACT

A speaker vector extraction unit (15b) extracts a speaker vector representing a speaker feature of each frame using a sequence of acoustic features for each frame of a latest acoustic signal. A learning unit (15d) generates an online EEND model (14a) for estimating a speaker label of the speaker vector of each frame through learning using the speaker vector and a speaker label representing a speaker of the estimated speaker vector.

### TECHNICAL FIELD

The present invention relates to a speaker diarization method, a speaker diarization device, and a speaker diarization program.

### BACKGROUND ART

In recent years, expectations have been high for a speaker diarization technique which uses an acoustic signal as an input and identifies speech sections of all speakers included in the acoustic signal. According to a speaker diarization technique, various applications are possible, such as, for example, automatic transcription in which a person who speaks and a time at which the person speaks are recorded in a conference, automatic extraction of speech between an operator and a customer from a call in a contact center, and the like.

In the related art, a technique called end-to-end neural diarization (EEND) based on deep learning has been disclosed as a speaker diarization technique (refer to NPL 1). In the EEND, an acoustic signal is divided into frames and a speaker label indicating whether a specific speaker exists in the frame is estimated for each frame from acoustic features extracted from each frame. When the maximum number of speakers in the audio signal is S, the speaker label for each frame is an S-dimensional vector which is 1 when a speaker is speaking and is 0 when the speaker is not speaking in that frame. That is to say, the EEND implements speaker diarization by performing multi-label binary classification of the number of speakers.

The EEND model used for estimating the speaker label sequence for each frame in the EEND is a deep learning-based model composed of layers capable of backpropagating errors and can estimate the speaker label sequence for each frame from the acoustic feature sequence all at once. The EEND model includes a recurrent neural network (RNN) layer which performs time-series modeling. As a result, in the EEND, it is possible to estimate the speaker label for each frame by using the acoustic feature amount of not only the current frame but also the surrounding frames. Bidirectional long short-term memory (LSTM)-RNN and Transformer Encoder are used in this RNN layer.

Note that NPL 2 describes the RNN Transducer. In addition, NPL 3 describes an acoustic feature amount.

### CITATION LIST

### Non Patent Literature

[NPL 1] Yusuke FUJITA, Naoyuki KANDA, Shota HORIGUCHI, Yawen XUE, Kenji NAGAMATSU, Shinji WATANABE, “END-TO-END NEURAL SPEAKER DIARIZATION WITH SELF-ATTENTION”, Proc. ASRU, 2019, pp. 296 to 303
[NPL 2] Alex GRAVES, “Sequence Transduction with Recurrent Neural Networks”, Proc. ICML, 2012
[NPL 3] Kiyohiro KANO, Katsunori ITO, Tatsuya KAWAHARA, Kazuya TAKEDA, Mikio YAMAMOTO, “Speech Recognition System”, Ohmsha, 2001, pp. 13 and 14

### SUMMARY OF INVENTION

### Technical Problem

However, on-line speaker diarization is difficult in the related art. In other words, since the EEND model in the related art uses a bidirectional LSTM-RNN or Transformer which refers to the entire acoustic feature sequence, it is difficult to achieve online speaker diarization.

The present invention was made in view of the above description, and an object of the present invention is to perform on-line speaker diarization.

### Solution to Problem

In order to solve the above-described problems and achieve the object, a speaker diarization method according to the present invention includes: an extraction step of extracting a speaker vector representing speaker features of each frame using an acoustic feature sequence for each frame of a most recent acoustic signal; and a learning step of generating a model for estimating a speaker label of a speaker vector of each frame by performing learning using the speaker vector and a speaker label representing a speaker of the estimated speaker vector.

### Advantageous Effects of Invention

According to the present invention, on-line speaker diarization becomes possible.

### BRIEF DESCRIPTION OF DRAWINGS

FIG. 1 is a diagram for explaining an outline of a speaker diarization device.

FIG. 2 is a schematic diagram illustrating a schematic configuration of the speaker diarization device.

FIG. 3 is a diagram for explaining processing of the speaker diarization device.

FIG. 4 is a flowchart for describing a speaker diarization processing procedure.

FIG. 5 is a flowchart for describing the speaker diarization processing procedure.

FIG. 6 is a diagram illustrating a computer executing a speaker diarization program.

### DESCRIPTION OF EMBODIMENTS

An embodiment of the present invention will be described in detail below with reference to the drawings. Note that the present invention is not limited by this embodiment. Moreover, in the description provided with reference to the drawings, the same constituent elements will be denoted by the same reference numerals.

### [Overview of Speaker Diarization Device]

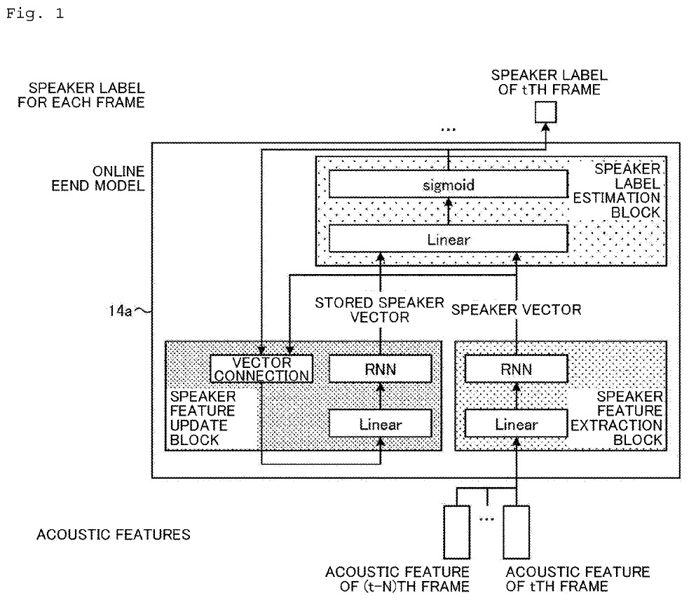

FIG. 1 is a diagram for explaining an outline of a speaker diarization device. As shown in FIG. 1, the EEND model (online EEND model) of the speaker diarization device of the embodiment constructs an online EEND model 14a which outputs a speaker vector representing the features of the speaker of the latest frame using a sequence of acoustic features for each frame of the most recent acoustic signal as an input. Specifically, the online EEND model 14a estimates a speaker label of a tth frame using the acoustic features of each frame from a current tth frame to a (t-N)th frame which are traced back continuously.

This online EEND model 14a has a speaker feature extraction block, a speaker feature update block, and a speaker label estimation block. Here, the speaker feature extraction block uses the acoustic features of each of the (t-N)th to tth frames to extract a speaker vector representing the feature of the tth frame speaker. Note that, although the speaker feature extraction block includes a Linear (fully connected) layer and an RNN layer in the example shown in FIG. 1, the present invention is not limited to this, and for example, an input vector averaging layer may be included instead of an RNN layer.

The speaker feature update block vector-connects and stores the speaker vector of the tth frame and the estimated speaker label estimated by the speaker label estimation block which will be described later for this speaker vector. Furthermore, the speaker feature update block updates the parameters of a model in which a speaker vector having information which identifies a speaker is output as a stored speaker vector in response to an input vector obtained by vector-connecting the stored speaker vector and an estimation value of the speaker label. In the example shown in FIG. 1, the model includes a Linear (fully connected) layer and an RNN layer.

The speaker label estimation block uses the speaker vector and the stored speaker vector to output the speaker label estimation value for the tth frame. In the example shown in FIG. 1, the speaker label estimation block includes a Linear (fully connected) layer and a sigmoid layer. The speaker diarization device estimates speaker labels by, for example, performing a threshold decision on the output speaker label estimation value.

In this way, the speaker diarization device estimates speaker labels frame by frame using the online EEND model 14a having an autoregressive structure. This allows the speaker diarization device to estimate speaker labels while updating the stored speaker vectors each time a frame is input. Therefore, it is possible to realize on-line speaker diarization.

### [Structure of Speaker Diarization Device]

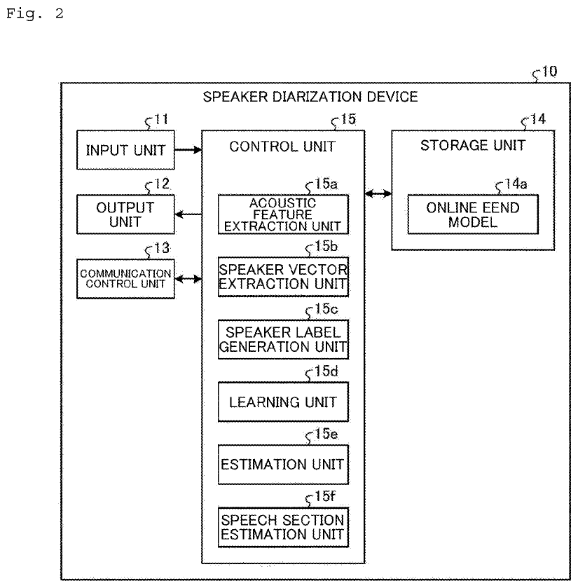

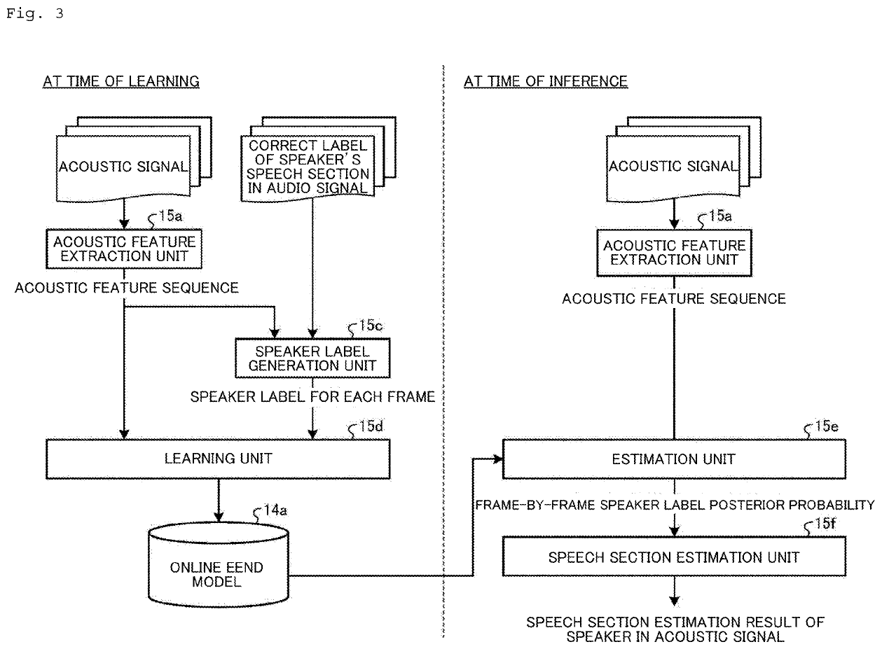

FIG. 2 is a schematic diagram illustrating a schematic configuration of the speaker diarization device. Furthermore, FIG. 3 is a diagram for explaining processing of the speaker diarization device. First, as illustrated in FIG. 2, a speaker diarization device 10 of the embodiment is implemented by a general-purpose computer such as a personal computer and includes an input unit 11, an output unit 12, a communication control unit 13, a storage unit 14, and a control unit 15.

The input unit 11 is implemented using an input device such as a keyboard and a mouse and inputs various instruction information such as processing start to the control unit 15 in response to an input operation by a practitioner. The output unit 12 is implemented by a display device such as a liquid crystal display, a printing device such as a printer, an information communication device, or the like. The communication control unit 13 is implemented by a network interface card (NIC) or the like and controls communication between the control unit 15 and an external device such as a server or a device which acquires an acoustic signal over a network.

The storage unit 14 is implemented by a semiconductor memory device such as a random access memory (RAM) or a flash memory, or a storage device such as a hard disk or an optical disc. Note that the storage unit 14 may be configured to communicate with the control unit 15 via the communication control unit 13. In the embodiment, the storage unit 14 stores, for example, the online EEND model 14a used for speaker diarization processing which will be described later.

The control unit 15 is implemented using a central processing unit (CPU), a network processor (NP), a field programmable gate array (FPGA), or the like and executes a processing program stored in a memory. As a result, as illustrated in FIG. 2, the control unit 15 functions as an acoustic feature extraction unit 15a, a speaker vector extraction unit 15b, a speaker label generation unit 15c, a learning unit 15d, an estimation unit 15e, and a speech section estimation unit 15f. Note that these functional units may be implemented in different hardware. For example, the learning unit 15d may be implemented as a learning device and the estimation unit 15e may be implemented as an estimating device. Also, the control unit 15 may include other functional units.

The acoustic feature extraction unit 15a extracts an acoustic feature for each frame of the acoustic signal including the speech of the speaker. For example, the acoustic feature extraction unit 15a receives an input of an acoustic signal via the input unit 11 or via the communication control unit 13 from a device which acquires an acoustic signal and the like. Furthermore, the acoustic feature extraction unit 15a divides the acoustic signal for each frame, extracts an acoustic feature vector by performing discrete Fourier transform or filter bank multiplication on the signal from each frame, and outputs an acoustic feature sequence coupled in a frame direction. In the embodiment, a frame length is 25 ms and a frame shift width is 10 ms.

Here, although the acoustic feature vector is, for example, a 24-dimensional Mel frequency cepstral coefficient (MFCC), the present invention is not limited to this. The acoustic feature vector may be another acoustic feature amount for each frame such as a Mel filter bank output.

The speaker vector extraction unit 15b extracts a speaker vector representing the speaker feature of each frame using the acoustic feature sequence for each frame of the latest acoustic signal. Specifically, the speaker vector extraction unit 15b generates a speaker vector by inputting the acoustic feature sequence acquired from the acoustic feature extraction unit 15a to the speaker feature extraction block shown in FIG. 1.

Note that the speaker vector extraction unit 15b may be included in a learning unit 15d and an estimation unit 15e which will be described later. For example, FIG. 3 which will be described later shows an example in which the learning unit and the estimation unit 15e perform the processing of the speaker vector extraction unit 15b.

The speaker label generation unit 15c uses the acoustic feature sequence to generate a speaker label for each frame. Specifically, as shown in FIG. 3, the speaker label generation unit 15c generates a speaker label for each frame using the acoustic feature sequence and the correct label of the speech section of the speaker. Thus, a set of an acoustic feature sequence and a speaker label for each frame is generated as teacher data used in the processing of the learning unit 15d which will be described later.

Here, when the number of speakers is S (speaker 1, speaker 2, . . . , speaker S), the speaker label of the tth frame (t=0, 1, . . . , T) is an S-dimensional vector. For example, when a frame of time txframe shift width is included in the speech section of any speaker, the value of the dimension corresponding to that speaker is 1 and the value of the other dimensions is 0. Therefore, the speaker label for each frame is a binary [0, 1] multi-label of T×S dimensions.

The description will be provided with reference to FIG. 2 again. The learning unit 15d generates the online EEND model 14a for estimating the speaker label of the speaker vector of each frame through learning using the speaker vector and the speaker label representing the speaker of the estimated speaker vector. Specifically, as shown in FIG. 3, the learning unit 15d learns the online EEND model 14a using a set of acoustic feature sequences and a speaker label for each frame as teacher data.

Here, the online EEND model 14a is composed of a plurality of layers including the RNN layer as shown in FIG. 1. In the embodiment, a unidirectional LSTM-RNN is applied as the RNN layer. It is also assumed that N=10 and a super vector obtained by integrating the acoustic feature vectors of each frame from the tth frame to the (t-N)th frame is input to the online EEND model 14a. Here, the acoustic feature vector is a zero vector when t-N is a negative value.

Furthermore, the online EEND model 14a also outputs the posterior probability of the speaker label for each frame in T×S dimensions. The learning unit 15d optimizes the parameters of each layer of the online EEND model 14a through backpropagating errors using the posterior probability of the speaker label for each frame and the multi-label binary cross entropy with the speaker label for each frame as the loss function. The learning unit 15d uses an online optimization algorithm using stochastic gradient descent for parameter optimization.

That is to say, the learning unit 15d vector-connects and stores the tth frame speaker vector extracted by the speaker vector extraction unit 15b which is a speaker feature extraction block using the acoustic features of each of the (t-N)th frame to the tth frame of the teacher data and the speaker label estimation value estimated by the speaker label estimation block for this speaker vector. Furthermore, the learning unit 15d inputs a vector obtained by vector-connecting the stored speaker vector and the estimation value of the speaker label into the speaker feature update block and updates the parameters of the model which outputs the stored speaker vector including the information identifying the speaker. In addition, the learning unit 15d inputs the speaker vector of the tth frame and the stored speaker vector to the speaker label estimation block and updates the parameters of the model that outputs the estimation value of the speaker label of the tth frame.

Thus, the learning unit 15d generates the online EEND model 14a using a plurality of stored combinations of speaker vectors and speaker labels of the estimated speaker vectors. This makes it possible to estimate the speaker label while updating the stored speaker vector each time a frame is input.

The description will be provided with reference to FIG. 2 again. The estimation unit 15e uses the generated online EEND model 14a to estimate the speaker label for each frame of the acoustic signal. Specifically, as shown in FIG. 3, the estimation unit 15e forward propagates, to the online EEND model 14a, the speaker vector of the tth frame extracted by the speaker vector extraction unit 15b using the acoustic features of each frame from the current tth frame of the acoustic feature sequence to the (t-N)th frame traced back continuously.

Since the online EEND model 14a has an autoregressive structure, the speaker label posterior probability (estimation value of the speaker label) for each frame of the acoustic feature sequence is output by successively sequentially propagating the acoustic feature sequence from the first frame.

The speech section estimation unit 15f uses the output speaker label posterior probability to estimate the speech section of the speaker in the acoustic signal. Specifically, the speech section estimation unit 15f estimates the speaker label using a moving average of a plurality of frames. That is to say, the speech section estimation unit 15f first calculates a moving average of the speaker label posterior probability for each frame over the length 6 of the current frame and the five frames immediately preceding it. This makes it possible to prevent erroneous detection of impractically short speech sections such as speech with only one frame.

Subsequently, when the calculated moving average value is greater than 0.5, the speech section estimation unit 15f estimates that the frame is the speech section of the speaker of the dimension. Moreover, for each speaker, the speech section estimation unit 15f regards a group of continuous speech section frames as one speech and calculates a start time and an end time of the speech section up to a predetermined time from the frames. Thus, the speech start time and the speech end time up to a predetermined time can be obtained for each speech of each speaker.

### [Speaker Diarization Processing]

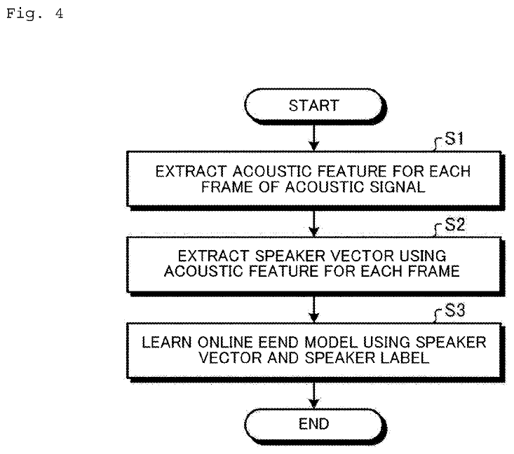

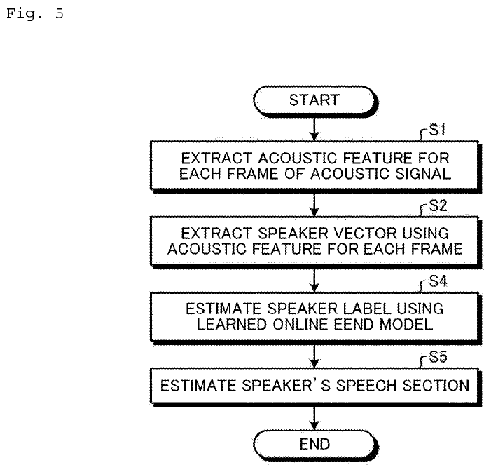

The speaker diarization processing by the speaker diarization device 10 will be described below. FIGS. 4 and 5 are flow charts showing the speaker diarization processing procedure. The speaker diarization processing of the embodiment includes learning processing and estimation processing. First, FIG. 4 shows the learning processing procedure. The flowchart in FIG. 4 is started, for example, at the timing at which an instruction to start the learning processing is received.

First, the acoustic feature extraction unit 15a extracts acoustic features for each frame of an acoustic signal including speech of a speaker and outputs an acoustic feature sequence (Step S1).

Subsequently, the speaker vector extraction unit 15b extracts a speaker vector representing the speaker feature of each frame using the acoustic feature sequence for each frame of the latest acoustic signal. (Step S2)

Furthermore, the learning unit 15d has an autoregressive structure using the speaker vector and the speaker label representing the speaker of the estimated speaker vector and generates the online EEND model 14a for estimating the speaker label of the speaker vector of each frame through learning (Step S3). This completes a series of learning processings.

Subsequently, FIG. 5 shows the estimation processing procedure. The flowchart of FIG. 5 is started, for example, when an input instructing the start of the estimation processing is received.

First, the acoustic feature extraction unit 15a extracts acoustic features for each frame of an acoustic signal including speech of a speaker and outputs an acoustic feature sequence (Step S1).

Also, the speaker vector extraction unit 15b extracts a speaker vector representing the speaker feature of each frame using the acoustic feature sequence for each frame of the latest acoustic signal (Step S2).

Subsequently, the estimation unit 15e uses the generated online EEND model 14a to estimate the speaker label for each frame of the acoustic signal (Step S4). Specifically, the estimation unit 15e outputs the speaker label posterior probability (estimation value of the speaker label) for each frame of the acoustic feature sequence.

Furthermore, the speech section estimation unit 15f uses the output speaker label posterior probability to estimate the speaker's speech section in the acoustic signal (Step S5). This completes a series of estimation processings.

As described above, in the speaker diarization device 10 of the embodiment, the speaker vector extraction unit 15b uses the acoustic feature sequence for each frame of the latest acoustic signal to extract a speaker vector representing the speaker feature of each frame. Also, the learning unit 15d generates the online EEND model 14a for estimating the speaker label of the speaker vector of each frame through learning using the speaker vector and the speaker label representing the speaker of the estimated speaker vector.

Thus, the speaker diarization device 10 can estimate a speaker label each time a frame is input by using the online EEND model 14a having an autoregressive structure. Therefore, it is possible to realize on-line speaker diarization.

In addition, the learning unit 15d generates the online EEND model 14a using a plurality of stored combinations of speaker vectors and the speaker labels of the estimated speaker vectors. This enables the speaker diarization device 10 to estimate speaker labels while updating the stored speaker vectors each time a frame is input. Therefore, on-line speaker diarization can be realized with higher accuracy.

Also, the estimation unit 15e estimates the speaker label for each frame of the acoustic signal using the generated online EEND model 14a. This enables on-line speaker diarization.

Also, the speech section estimation unit 15f estimates the speaker label using the moving average of a plurality of frames. This makes it possible to prevent erroneous detection of impractically short speech sections.

### [Program]

It is also possible to create a program in which the processing executed by the speaker diarization device 10 according to the above embodiment is described in a computer-executable language. As one embodiment, the speaker diarization device 10 can be implemented by installing a speaker diarization program for executing the above-described speaker diarization processing as package software or online software on a desired computer. For example, the information processing device can function as the speaker diarization device 10 by causing the information processing device to execute the speaker diarization program. In addition, information processing devices include mobile communication terminals such as smartphones, mobile phones and personal handyphone systems (PHSs), and slate terminals such as personal digital assistant (PDA). Also, the functions of the speaker diarization device 10 may be implemented in a cloud server.

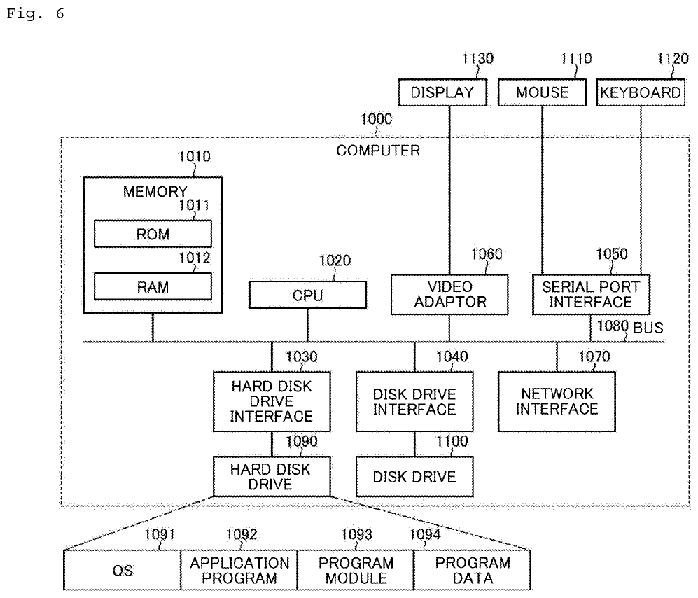

FIG. 6 is a diagram showing an example of a computer that executes a speaker diarization program. A computer 1000 includes, for example, a memory 1010, a CPU 1020, a hard disk drive interface 1030, a disk drive interface 1040, a serial port interface 1050, a video adapter 1060, and a network interface 1070. These units are connected through a bus 1080.

The memory 1010 includes a read only memory (ROM) 1011 and a RAM 1012. The ROM 1011 stores a boot program such as a basic input output system (BIOS). The hard disk drive interface 1030 is connected to a hard disk drive 1031. The disk drive interface 1040 is connected to a disk drive 1041. A removable storage medium such as a magnetic disk or an optical disk is, for example, inserted into the disk drive 1041. A mouse 1051 and a keyboard 1052 are, for example, connected to the serial port interface 1050. A display 1061 is, for example, connected to the video adapter 1060.

Here, the hard disk drive 1031 stores, for example, an OS 1091, an application program 1092, a program module 1093, and program data 1094. Each piece of information described in the above embodiment is stored in, for example, the hard disk drive 1031 or the memory 1010.

Also, the speaker diarization program is stored on the hard disk drive 1031 as, for example, the program module 1093 in which instructions to be executed by a computer 1000 are described. Specifically, the hard disk drive 1031 stores a program module 1093 in which each processing executed by the speaker diarization device 10 described in the above embodiment is described.

Also, data used for information processing by the speaker diarization program is stored, for example, as the program data 1094 in the hard disk drive 1031. Furthermore, the CPU 1020 reads out the program module 1093 and the program data 1094 stored in the hard disk drive 1031 to the RAM 1012 as necessary and performs each procedure described above.

Note that the present invention is not limited to a case in which the program module 1093 and the program data 1094 relating to the speaker diarization program are stored in the hard disk drive 1031 and the program module 1093 and the program data 1094 relating to the speaker diarization program may be stored in, for example, a removable storage medium and read by the CPU 1020 via the disk drive 1041 or the like. Alternatively, the program modules 1093 and the program data 1094 relating to the speaker diarization program may be stored in other computers connected over a network such as a local area network (LAN) or a wide area network (WAN) and read by the CPU 1020 via the network interface 1070.

Although the embodiments to which the invention made by the present inventor is applied have been described above, the present invention is not limited by the descriptions and drawings forming a part of the disclosure of the present invention according to the embodiments. That is to say, other embodiments, examples, operation techniques, and the like made by those skilled in the art on the basis of the embodiment are all included in the scope of the present invention.

### REFERENCE SIGNS LIST

10 Speaker diarization device
11 Input unit
12 Output unit
13 Communication control unit
14 Storage unit
14a Online EEND model
15 Control unit
15a Acoustic feature extraction unit
15b Speaker vector extraction unit
15c Speaker label generation unit
15d Learning unit
15e Estimation unit
15f Speech section estimation unit

1. A speaker diarization method performed by a speaker diarization device, comprising:
an extraction step of extracting a speaker vector, wherein the speaker vector represents speaker features of a frame using an acoustic feature sequence for the frame of a acoustic signal for learning; and
a learning step of generating a model by performing learning using the speaker vector and a speaker label representing a speaker of the speaker vector as training data, wherein the model, when generated, is for estimating the speaker label as output based on the speaker vector of each frame as input.

2. The speaker diarization method according to claim 1, wherein the learning step further comprises using a plurality of stored combinations of the speaker vectors and speaker labels of the speaker vectors to generate the model.

3. The speaker diarization method according to claim 1, further comprising:
an estimating step of estimating a speaker label for each frame of the acoustic signal using the generated model.

4. The speaker diarization method according to claim 3, wherein the estimating step further comprises using a moving average of a plurality of frames to estimate the speaker label.

5. A speaker diarization device, comprising a processor configured to execute operations comprising:
extracting a speaker vector, wherein the speaker vector represents speaker features of a frame using an acoustic feature sequence for the frame of a acoustic signal for learning; and
generating a model by performing learning using the speaker vector and a speaker label representing a speaker of the speaker vector as training data, wherein the model, when generated, is for estimating the speaker label as output based on the speaker vector of the frame as input.

6. A computer-readable non-transitory recording medium storing computer-executable speaker diarization program instructions that when executed by a processor cause a computer system to execute operations comprising:
extracting a speaker vector, wherein the speaker vector represents speaker features of a frame using an acoustic feature sequence for the frame of a most recent acoustic signal for learning; and
generating a model by performing learning using the speaker vector and a speaker label representing a speaker of the speaker vector, as training data, wherein the model, when generated, is for estimating the speaker label as output based on the speaker vector of a frame as input.

7. The speaker diarization method according to claim 1, wherein the model includes a deep learning-based model, the deep learning-based model comprises a plurality of layers, the plurality of layers performs backpropagating errors and estimates a sequence of speaker labels for the frame of the acoustic signal.

8. The speaker diarization method according to claim 1, wherein the model estimates a speaker label of the frame using the acoustic features of each frame from the frame to a predetermined frame by iteratively tracing back frames, wherein the predetermined frame corresponds to a previous frame that is prior to the frame by a predetermined number of frames.

9. The speaker diarization method according to claim 1, wherein the model includes a combination of a fully connected layer and a recurrent neural network layer.

10. The speaker diarization device according to claim 5, wherein the learning further comprises using a plurality of stored combinations of the speaker vectors and speaker labels of the speaker vectors to generate the model.

11. The speaker diarization device according to claim 5, the processor further configured to execute operations comprising:
estimating a speaker label for each frame of the acoustic signal using the generated model.

12. The speaker diarization device according to claim 11, wherein the estimating further comprises using a moving average of a plurality of frames to estimate the speaker label.

13. The speaker diarization device according to claim 5, wherein the model includes a deep learning-based model, the deep learning-based model comprises a plurality of layers, the plurality of layers performs backpropagating errors and estimates a sequence of speaker labels for the frame of the acoustic signal.

14. The speaker diarization device according to claim 5, wherein the model estimates a speaker label of the frame using the acoustic features of each frame from the frame to a predetermined frame by iteratively tracing back frames, wherein the predetermined frame corresponds to a previous frame that is prior to the frame by a predetermined number of frames.

15. The speaker diarization device according to claim 5, wherein the learning further comprises using a plurality of stored combinations of the speaker vectors and speaker labels of the speaker vectors to generate the model.

16. The computer-readable non-transitory recording medium according to claim 6, wherein the learning further comprises using a plurality of stored combinations of the speaker vectors and speaker labels of the speaker vectors to generate the model.

17. The computer-readable non-transitory recording medium according to claim 6, the computer-executable program instructions when executed further causing the computer system to execute operations comprising:
estimating a speaker label for each frame of the acoustic signal using the generated model.

18. The computer-readable non-transitory recording medium according to claim 17, wherein the estimating further comprises using a moving average of a plurality of frames to estimate the speaker label.

19. The computer-readable non-transitory recording medium according to claim 6, wherein the model includes a deep learning-based model, the deep learning-based model comprises a plurality of layers, the plurality of layers performs backpropagating errors and estimates a sequence of speaker labels for the frame of the acoustic signal.

20. The computer-readable non-transitory recording medium according to claim 6, wherein the model estimates a speaker label of the frame using the acoustic features of each frame from the frame to a predetermined frame by iteratively tracing back frames, wherein the predetermined frame corresponds to a previous frame that is prior to the frame by a predetermined number of frames.
